(19) United States
(12) Patent Application Publication
(10) Pub. No.: US 2025/0348308 A1
(43) Pub. Date: Nov. 13, 2025

(54) CUSTOMIZED LANDING ZONE CODE CONFIGURATION AND DEPLOYMENT

(71) Applicant: Microsoft Technology Licensing, LLC, Redmond, WA (US)

(72) Inventor: Kevin Patrick RABUN, Weaverville, NC (US)

(21) Appl. No.: 18/772,084

(22) Filed: Jul. 12, 2024

Related U.S. Application Data
(60) Provisional application No. 63/643,903, filed on May 7, 2024.

(51) Int. Cl. G06F 8/71; G06F 8/60

(52) U.S. Cl. CPC G06F 8/71; G06F 8/60

(57) ABSTRACT

Examples provide a customized landing zone code generation. A landing zone manager obtains customized configuration data from a user via a set of prompts. The prompts are provided as a series of queries to obtain configuration data via a user interface. A customized configuration file is created using the customized configuration data obtained from a user in response to the set of prompts and a configuration template. The configuration file is validated. Customized landing zone code is generated using the validated customized configuration file. The customized configuration file includes user-specific policies. A customized landing zone infrastructure defined by the customized configuration file using the customized landing zone code to perform workloads via a cloud server.

### BACKGROUND

One of the main concerns for public sector customers interested in adopting commercial cloud solutions is maintaining control over their data and infrastructure, especially with regards to governance and compliance requirements. This can be especially challenging for public sector organizations, as they must adhere to strict regulations and guidelines, and must be able to demonstrate that their data is secure. Additionally, configuring and deploying workloads into new and existing cloud computing environments can be complex and difficult, especially when having to meet specific sovereignty and compliance requirements.

### SUMMARY

Some examples provide a system and method for cloud infrastructure customization and deployment using a low-code approach for configuring and developing infrastructure-as-code (IaC) in cloud computing environments. A landing zone manager obtains configuration data from a user in response to a set of prompts provided to the user via a user interface device. The prompts include a series of queries for guiding the user through the configuration process. A customized configuration file is generated using the configuration data and a configuration template. The configuration file is validated. A landing zone code is generated using the configuration file. The landing zone code is deployed in a cloud environment that is compliant with the customized policies and configurations of the user.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE DRAWINGS

FIG. 1 is an exemplary block diagram illustrating a system for cloud infrastructure configuration and development using a low-code approach for customized configurations and deployment in cloud computing environments.

FIG. 2 is an exemplary block diagram illustrating a landing zone manager enabling customized landing zone development and deployments.

FIG. 3 is an exemplary flow chart illustrating operation of the computing device to create customized landing zone generation code.

FIG. 4 is an exemplary flow chart illustrating operation of the computing device to validate landing zone generation code created using customized landing zone configuration files.

FIG. 5 is an exemplary flow chart illustrating operation of the computing device to provide customized sovereign landing zone generation code based on user-provided configuration data.

FIG. 6 is an exemplary screenshot illustrating a home page for sovereign landing zone architecture configuration and development.

FIG. 7 is an exemplary screenshot illustrating options for creating a customized sovereign landing zone, customized polices and workloads for execution on a sovereign landing zone architecture.

FIG. 8 is an exemplary screenshot illustrating options for creating, deploying, and exporting a customized landing zone configuration.

FIG. 9 is an exemplary screenshot illustrating a configuration page for creating infrastructure as code (IaC) for a sovereign landing zone.

FIG. 10 is an exemplary screenshot illustrating a configuration page for obtaining customized parameters for creating and deploying a landing zone architecture.

FIG. 11 is an exemplary screenshot illustrating a review page for a customized landing zone configuration.

FIG. 12 is an exemplary screenshot illustrating an overview of deployed landing zones.

FIG. 13 is an exemplary screenshot illustrating a library of landing zone configuration templates.

FIG. 14 is an exemplary screenshot illustrating a confirmation message for deleting a landing zone configuration template.

FIG. 15 is an exemplary screenshot illustrating a page for exporting a landing zone configuration template.

FIG. 16 is an exemplary screenshot illustrating a landing zone deployment confirmation page.

FIG. 17 is a block diagram of an example computing device for implementing aspects disclosed herein and is designated as computing device.

Corresponding reference characters indicate corresponding parts throughout the drawings.

### DETAILED DESCRIPTION

A more detailed understanding can be obtained from the following description, presented by way of example, in conjunction with the accompanying drawings. The entities, connections, arrangements, and the like that are depicted in, and in connection with the various figures, are presented by way of example and not by way of limitation. As such, any and all statements or other indications as to what a particular figure depicts, what a particular element or entity in a particular figure is or has, and any and all similar statements, that can in isolation and out of context be read as absolute and therefore limiting, can only properly be read as being constructively preceded by a clause such as “In at least some examples, . . . ” For brevity and clarity of presentation, this implied leading clause is not repeated ad nauseum.

Some of the most common challenges to cloud computing services adoption for public sector customers are data residency, lawful access, and autarky. Data residency refers to the physical location of where data is stored and can apply to data at rest, data in transit, data in use, and/or data at temporary rest depending on the governing laws and policies. Lawful access refers to a concern that legal process can be served against a cloud provider to compel lawful disclosure of stored data. Capabilities to help mitigate concerns around data residency, autarky, and lawful access are desirable in cloud architecture and data management.

Customization can be challenging in large infrastructure-as-code projects. More non-technical subject matters experts frequently need to be included in the infrastructure configuration and analysis process to provide perspectives on policy, legality, and security of environments. This results in additional friction and potential roadblocks to cloud adoption for some users.

Referring to the figures, examples of the disclosure enable low code or no code approach to architecture configuration and development in cloud computing environments. In some examples, the system enables creation of a customized configuration file including customized policy sets and/or other customized configuration data provided by the user in response to a series of prompts. The customized configuration data enables creation of customized landing zone code while minimizing system resource usage, such as processor and memory resources, which would otherwise be consumed during manual configuration file creation.

In other examples, the system outputs a series of prompts via a user interface that guides the user through a configuration process in a quick and efficient manner that reduces user time and network bandwidth usage during generation of the configuration file. This enables improved user efficiency via the UI interaction and increased user interaction performance while reducing the time required to create a customized configuration file.

In other examples, the system generates customized landing zone code automatically using the customized configuration file. The landing zone code generation is performed in an automated fashion that minimizes human interaction with the system while improving the accuracy and reliability of the produced landing zone code. This enables reduced processor load which would be consumed during manual code generation, reduced memory and data storage required to create customized IaC code, and reduced error rate in the produced IaC landing zone code.

Some aspects of the disclosure provides a landing zone manager that enables users to easily create and configure landing zones that meet their specific sovereignty and regulatory compliance requirements. This is accomplished using advanced code generation capabilities that automatically generate code from configuration data, eliminating the need for manual coding and ensuring that landing zones are fully compliant with all relevant regulations. With this powerful feature, users can quickly and easily create secure, compliant landing zones that meet their specific business needs. Additionally, users have the flexibility to export their custom configured code using either the cloud portal or application programming interface (API) calls. This feature allows for further customization and allows for easy integration into existing workflows while reducing system resource usage, such as network bandwidth usage and memory usage.

Other aspects of the disclosure guide users through the process of configuring, updating, reviewing, generating, and deploying landing zone code for cloud architecture. This enables faster and more accurate configuration and deployment of landing zone architecture using customized code created using the configuration template and user responses to the series of prompts. The computing device operates in an unconventional manner by automatically configuring, validating, and deploying landing zone architectures using both static data and dynamically customized data based on user-provided configuration data and/or customized policy data to reduce system resource usage and improve user efficiency via the user interface. In this manner, the computing device is used in an unconventional manner and allows more accurate landing zone architecture creation and deployment customized to the specific needs and requirements of users while reducing errors by validating the configuration data and generated code in real-time, thereby improving the functioning of the underlying computing device.

The system, in still other examples, provides a consistent, auditable, automatable experience for hosting workloads on a cloud platform with a focus on mitigating issues associated with data residency and lawful access responses. The system performs validation of configuration files and/or generated code to compare and review policy initiatives to ensure regulatory and legal compliance. This further enables users to use their existing, human readable, policies as a basis for comparison with customized configuration files that are validated and exported for use in automation pipelines which accelerate user understanding for how to configure and customize the sovereign landing zone (SLZ) moving forward.

In other examples, the system provides prompts and a configuration template for additional levels of policy customization that can be layered on top of the generated SLZ to enforce security policies set by the user, such as a human user, organization, agency, or other entity. The system enables flexibility in the customization and configuration of the cloud architecture, policy, and workload deployments to further meet the unique needs and requirements of various users, organizations, agencies, and missions.

The customized and guided code generation capability for landing zones provided in other examples addresses common drawbacks for managing infrastructure-as-code projects. The code generation approach avoids manual configuration and enforces consistency by representing desired environment states via well-documented code in formats, such as Java Script Object Notation (JSON) format. This reduces the amount of time and effort required to build and maintain infrastructure, as users do not need to have as much expertise or experience with programming, making it easier to onboard new team members or get non-technical stakeholders involved in infrastructure decisions. Additionally, it can help to reduce the risk of errors or inconsistencies in code, since human error is less likely to cause issues with a no-code or low-code approach.

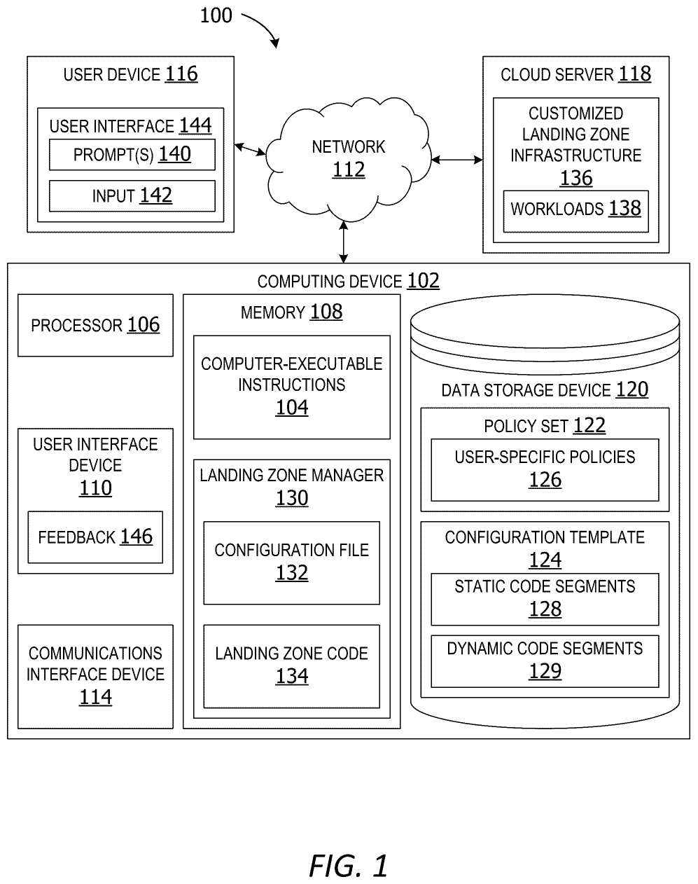

Referring again to FIG. 1, an exemplary block diagram illustrates a system 100 for cloud infrastructure configuration and development using a low-code approach for customized configurations and deployment in cloud computing environments. In the example of FIG. 1, the computing device 102 represents any device executing computer-executable instructions 104 (e.g., as application programs, operating system functionality, or both) to implement the operations and functionality associated with the computing device 102. The computing device 102, in some examples includes a mobile computing device or any other portable device. A mobile computing device includes, for example but without limitation, a mobile telephone, laptop, tablet, computing pad, netbook, gaming device, and/or portable media player. The computing device 102 can also include less-portable devices such as servers, desktop personal computers, kiosks, or tabletop devices. Additionally, the computing device 102 can represent a group of processing units or other computing devices.

In some examples, the computing device 102 has at least one processor 106 and a memory 108. The computing device 102, in other examples includes a user interface device 110.

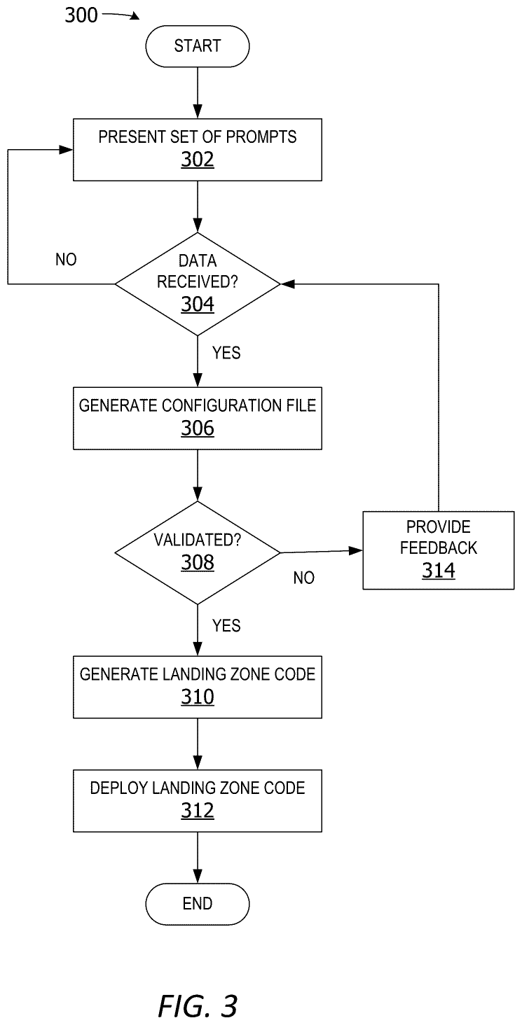

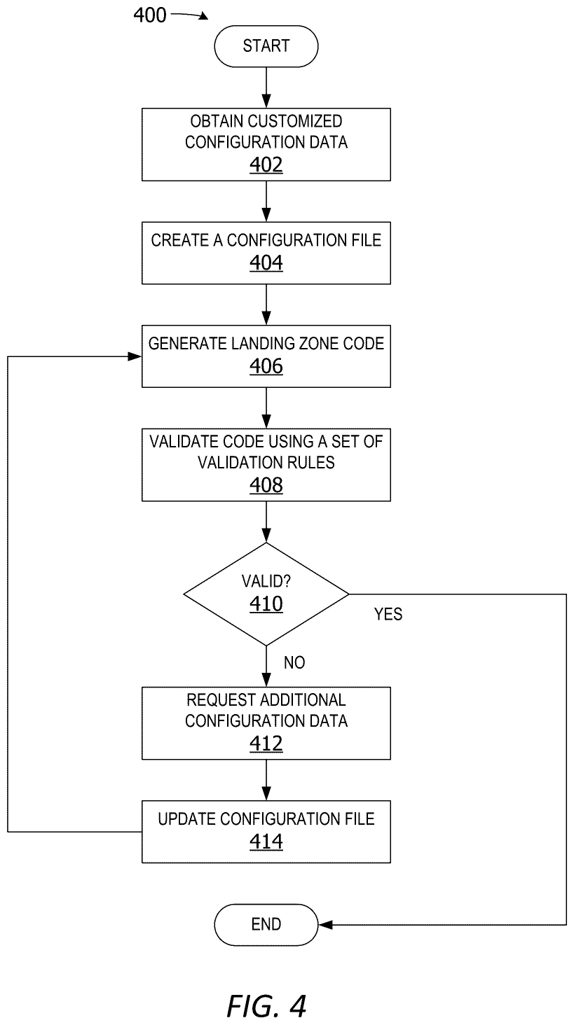

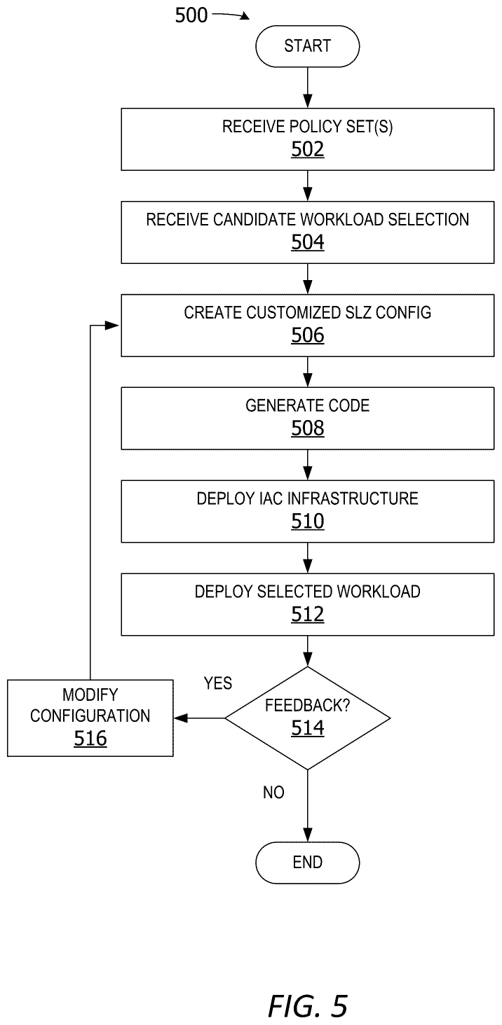

The processor 106 includes any quantity of processing units and is programmed to execute the computer-executable instructions 104. The computer-executable instructions 104 are performed by the processor 106, performed by multiple processors within the computing device 102 or performed by a processor external to the computing device 102. In some examples, the processor 106 is programmed to execute instructions such as those illustrated in the figures (e.g., FIG. 3, FIG. 4, and FIG. 5).

The computing device 102 further has one or more computer-readable media such as the memory 108. The memory 108 includes any quantity of media associated with or accessible by the computing device 102. The memory 108 in these examples is internal to the computing device 102 (as shown in FIG. 1). In other examples, the memory 108 is external to the computing device (not shown) or both (not shown). The memory 108 can include read-only memory and/or memory wired into an analog computing device.

The memory 108 stores data, such as one or more applications. The applications, when executed by the processor 106, operate to perform functionality on the computing device 102. The applications can communicate with counterpart applications or services such as web services accessible via a network 112. In an example, the applications represent downloaded client-side applications that correspond to server-side services executing in a cloud.

In other examples, the user interface device 110 includes a graphics card for displaying data to the user and receiving data from the user. The user interface device 110 can also include computer-executable instructions (e.g., a driver) for operating the graphics card. Further, the user interface device 110 can include a display (e.g., a touch screen display or natural user interface) and/or computer-executable instructions (e.g., a driver) for operating the display. The user interface device 110 can also include one or more of the following to provide data to the user or receive data from the user: speakers, a sound card, a camera, a microphone, a vibration motor, one or more accelerometers, a BLUETOOTH® brand communication module, wireless broadband communication (LTE) module, global positioning system (GPS) hardware, and a photoreceptive light sensor. In a non-limiting example, the user inputs commands or manipulates data by moving the computing device 102 in one or more ways.

The network 112 is implemented by one or more physical network components, such as, but without limitation, routers, switches, network interface cards (NICs), and other network devices. The network 112 is any type of network for enabling communications with remote computing devices, such as, but not limited to, a local area network (LAN), a subnet, a wide area network (WAN), a wireless (Wi-Fi) network, or any other type of network. In this example, the network 112 is a WAN, such as the Internet. However, in other examples, the network 112 is a local or private LAN.

In some examples, the system 100 optionally includes a communications interface device 114. The communications interface device 114 includes a network interface card and/or computer-executable instructions (e.g., a driver) for operating the network interface card. Communication between the computing device 102 and other devices, such as but not limited to a user device 116 and/or a cloud server 118, can occur using any protocol or mechanism over any wired or wireless connection.

The user device 116 represents any device executing computer-executable instructions. The user device 116 can be implemented as a mobile computing device, such as, but not limited to, a wearable computing device, a mobile telephone, laptop, tablet, computing pad, netbook, gaming device, and/or any other portable device. The user device 116 includes at least one processor and a memory. The user device 116 can also include a user interface device.

The cloud server 118 is a logical server providing services to the computing device 102 or other clients, such as, but not limited to, the user device 116. The cloud server 118 is hosted and/or delivered via the network 112. In some non-limiting examples, the cloud server 118 is associated with one or more physical servers in one or more data centers. In other examples, the cloud server 118 is associated with a distributed network of servers.

The system 100 can optionally include a data storage device 120 for storing data, such as, but not limited to a policy set 122 and/or a configuration template 124. The policy set 122 is a customized set of user-specific policies 126. A user-specific policy is a policy that is provided by the user, created by the user and/or customized or modified for the user. In some examples, a user uploads the policy set 122 from the user device 116 via the network 112. In other examples, the policy set is downloaded from a remote data storage, such as the data storage device 120 and/or a cloud storage, such as a data storage on the cloud server 118.

The configuration template 124 is a template including static code segments 128 and dynamic code segments 129 used by a landing zone manager 130 to generate a customized configuration file 132.

In some examples, the customized configuration file 132 is a file including customized configuration data. In some examples, the landing zone manager 130 provides a series of one or more prompt(s) 140 to the user via a user interface device, such as, but not limited to, the user interface device 110 and/or the user interface 144 of the user device 116. The user provides input 142, including data responsive to the prompt(s) 140 via the user interface 144. The input 142 includes customized configuration data used by the landing zone manager 130 to generate the customized configuration file 132.

The landing zone manager 130 is a software component providing a sovereign landing zone code generation functionality and/or customized policies (sovereign policies). The landing zone manager 130 services may be referred to as sovereign services. The customized configuration file 132, in some examples, is used by the landing zone manager 130 to generate landing zone code 134 used to deploy a customized landing zone infrastructure 136, such as IaC for executing one or more workloads 138. Different workloads can be deployed on different cloud platforms.

The data storage device 120 can include one or more different types of data storage devices, such as, for example, one or more rotating disks drives, one or more solid state drives (SSDs), and/or any other type of data storage device. The data storage device 120 in some non-limiting examples includes a redundant array of independent disks (RAID) array. In some non-limiting examples, the data storage device(s) provide a shared data store accessible by two or more hosts in a cluster. For example, the data storage device may include a hard disk, a redundant array of independent disks (RAID), a flash memory drive, a storage area network (SAN), or other data storage device. In other examples, the data storage device 120 includes a database.

The data storage device 120 in this example is included within the computing device 102, attached to the computing device, plugged into the computing device, or otherwise associated with the computing device 102. In other examples, the data storage device 120 includes a remote data storage accessed by the computing device via the network 112, such as a remote data storage device, a data storage in a remote data center, or a cloud storage.

The landing zone manager 130 validates the customized configuration file 132, in some examples, to ensure the configuration file is complete and accurate. If the configuration file 132 fails the validation (unvalidated configuration file), the landing zone manager 130 reports the validation failure to the user via feedback 146. The feedback 146 optionally includes an identification of any errors in the configuration file, missing data or other information required to complete the configuration file, and/or any additional corrections required to enable validation of the configuration file.

In other examples, the landing zone manager 130 validates the landing zone code 134 generated based on the configuration file 132. If the landing zone code 134 is validated, the landing zone code is authorized for deployment. If the landing zone code fails to be validated (unvalidated), the landing zone code is not deployed. Instead, the landing zone manager 130 generates feedback 146 to the user. The feedback optionally identifies errors in the landing zone code, additional information needed to correct or update the landing zone code, and/or otherwise correct the landing zone code and/or the configuration file used to generate the landing zone code.

The memory 108 in some examples stores one or more computer-executable components, such as, the landing zone manager 130. The landing zone manager 130 configures, generates, validates, updates, and deploys customized landing zone infrastructure configured to meet the unique and specific requirements of a user, business, agency, or other entity. The landing zone manager component, when executed by the processor 106 of the computing device 102, presents the set of one or more prompt(s) 140 requesting customized configuration data corresponding to a set of dynamic code segments of the landing zone configuration template 124 via the user interface device 110 and/or the user interface 144. The landing zone configuration template 124 includes one or more static code segments and one or more dynamic code segments 129. The customized configuration file 132 is created using the customized configuration data obtained from the user in response to the prompt(s) 140 and the one or more static code segments. The customized configuration file 132 is a file that contains the required user choices used to generate code for deploying cloud infrastructure.

The customized landing zone code 134 is generated using the customized configuration file. The customized configuration file 132 includes one or more user-specific policies 126 in one or more policy sets, such as, but not limited to, the policy set 122. The landing zone manager 130 validates the customized landing zone code 134 for compliance with the set of user-specific policies. The customized landing zone infrastructure 136 defined by the customized configuration file is deployed using the customized landing zone code to perform workloads 138 within a cloud environment, such as, but not limited to, the cloud server 118.

In some examples, the landing zone manager provides a graphical user interface (GUI) driven and/or API driven approach to creating customized landing zone configurations. The landing zone configurations, as defined in the configuration files) are then used to generate customized landing zone IaC projects for export and use within existing automation solutions of users. The system 100 enables users to manage their IaC, using the service as an accelerator to create the appropriate landing zones based on their configuration choices and export for use in existing pipelines. The system 100 enables users to configure and deploy landing zone code without needing to generate or manage IaC for their landing zone directly.

In other examples, the landing zone manager 130 enables a user to generate tailored SLZ code based on configuration data, download a version of the SLZ generated from the user's customized configuration data, and/or generate tailored SLZ code based on configuration data via the cloud portal and API calls.

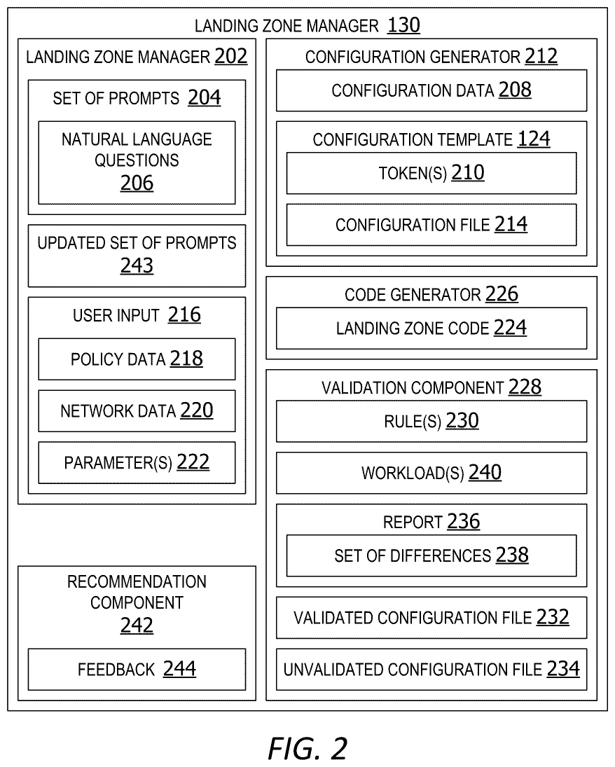

FIG. 2 is an exemplary block diagram illustrating a landing zone manager 130 enabling customized landing zone development and deployments. In some examples, a prompt manager component 202 presents a set of prompts 204 requesting customized configuration data 208 from a user. The set of prompts 204 include one or more natural language questions 206 present to the user in a series of queries or a list of questions prompting the user to provide input. The input includes user preferences, customized policy data, rules, regulations, laws, and other user-selected parameters and other requirements for a landing zone infrastructure.

In some examples, the set of prompts 204 are configured to obtain information corresponding to a set of dynamic code segments of a landing zone configuration template. The information obtained in response to the prompts is mapped to one or more token(s) 210 of the configuration template 124. The token(s) 210 in the dynamic code segments of the configuration template are replaced with the information provided by the user. In other words, the information provided by the user defines customized parameters used to replace the dynamic code segments in the configuration template 124. The user-provided information and the static segments of code in the configuration template are used by the configuration generator 212 to create a customized configuration file 214.

In other examples, the prompt manager component 202 outputs a prompt in the set of prompts to a user via a GUI and/or an API. If the user provides user input 216 to the prompt, information contained in the user input 216, such as policy data 218, network data 220, and/or one or more other parameter(s) 222 are mapped to a dynamic code segment of the configuration template 124. The policy data 218 is data associated with one or more policies in one or more policy sets provided by the user. The network data 220 is data associated with network configurations and/or other network protocols to be implemented with the cloud architecture created by the landing zone manager 130 using the customized configuration file 214.

In other examples, the landing zone manager 130 creates a customized configuration file 214 using the customized configuration data 208 extracted from the user input 216 obtained in response to the set of prompts 204 and the configuration template 124. A code generator 226 of the landing zone manager 130 generates customized landing zone code 224 using the customized configuration file 214. The customized configuration file includes policy data 218, such as, pre-defined (non-customized) policies and/or user-specific (customized) policies provided by the user. The user-specific policies include one or more policies which are customized for a specific user, agency, government, business, organization, or other entity.

The landing zone manager 130, in some examples, includes a validation component 228 that validates the customized landing zone code 224 for compliance with the set of user-specific policies, such as the policies defined by the policy data 218. In this example, the validation component 228 is a rules engine that evaluates or reviews the configuration file 214 and/or the generated landing zone code 224 for compliance with one or more rule(s) 230. The rule(s) 230 are generated based on the user input, such as the policy data 218 and/or the parameter(s) 222. If the validation component 228 determines the configuration file is compliant with the rule(s) 230, the file is identified as a validated configuration file 232. A validated configuration file is approved for deployment or use in generating landing zone code 224. An unvalidated configuration file 234 fails to comply with one or more of the rule(s) 230.

In other examples, the validation component 228 validates the landing zone code 224 generated based on the configuration file for compliance with one or more of the rule(s) 230. If the landing zone code is validated, the code is used to deploy cloud infrastructure for executing one or more workload(s) 240. If the landing zone code fails to be validated, the landing zone code 224 is not deployed. Instead, the prompt manager component 202 optionally provides an updated set of prompts 243 to the user designed to obtain additional information from the user required to correct any errors or deficiencies in either the configuration file 214 and/or the landing zone code 224 generated based on the configuration file.

In other examples, the validation component generates a report 236 detailing a set of differences 238 between the configuration file and/or the landing zone code 224 and the rule(s). In other words, the system generates a report that indicates any errors or issues in the configuration file and/or landing zone code which renders the configuration file and/or landing zone code non-compliant with the rule(s). The rule(s) include the policies, network requirements, and any other parameters, such as the parameter(s) 222 for the cloud architecture being configured and deployed by the landing zone manager.

In still other examples, the landing zone manager includes a recommendation component 242 which provides feedback 244 to the user. The feedback indicates whether the landing zone configuration file and/or the landing zone code is validated or invalidated. If the configuration file and/or the landing zone code is invalidated, the feedback includes a recommendation for corrective action which is predicted to correct the issues preventing the configuration file and/or landing zone code from being validated.

The corrective action optionally provides one or more actions predicted to correct the issue preventing validation of the configuration file and/or the landing zone code. The corrective action can include changing policies, updating policies, providing additional configuration information, responding to the set of updated prompts 243, providing missing information, deleting erroneous information or requirements, deleting a conflicting requirement from the policy data and/or the parameter(s), etc.

In other examples, the landing zone manager 130 deploys a customized landing zone infrastructure defined by the customized configuration file 214 using the customized landing zone code 224 to perform workload(s) 240 via a cloud environment, such as, but not limited to, the cloud server 118 in FIG. 1.

The landing zone manager 130, in other examples, generates an SLZ that is tailored for a specific user based on the user-provided configuration data (user input). The generated SLZ, in one example, is a tailored collection of files in selected format, such as, but not limited to, a Bicep format. However, the examples are not limited to Bicep format.

The generated files are deployable without modification and generate the correct infrastructure in the cloud environment. In other examples, API registration/onboarding is part of the exported IaC code to automatically onboard to the sovereign services monitoring during deployment. The deployed landing zone is automatically mapped to the configuration that is used to generate it by the landing zone manager. This functionality is dependent on the completion of the onboarding and validation of the SLZ code.

FIG. 3 is an exemplary flow chart illustrating operation of the computing device to create customized landing zone generation code. The process 300 shown in FIG. 3 is performed by a landing zone manager component, executing on a computing device, such as the computing device 102 or the user device 116 in FIG. 1.

The process begins by presenting a set of prompts to a user at operation 302. The prompts are presented to the user via a user interface device, such as, but not limited to, the user interface device 110 and/or the user interface 144 in FIG. 1. The prompts are optionally presented one at a time in series or in sets of two or more. In this example, the prompts are natural language queries requesting customized configuration data from the user. A determination is made whether the requested configuration data is received from the user in response to the set of prompts at operation 304. If not, the landing zone manager presents one or more additional prompts requesting the needed configuration data. If the data is received at 304, the landing zone manager generates a customized configuration file at operation 306. The customized configuration file is generated using static portions of code as well as dynamic portions of code generated in real-time using the configuration data provided by the user in response to the prompts and/or any customized policy data input by the user.

A determination is made whether the configuration file is validated at operation 308. If yes, the landing zone manager generates landing zone code based on the configuration file at operation 310. The landing zone code is deployed at operation 312. The process terminates thereafter.

If the configuration file is not validated at 308, the landing zone manager provides feedback to the user at operation 314. The feedback includes information identifying any issues (problems) associated with the configuration file and/or requests additional corrective action by the user. The corrective action can include providing additional information (data) used to modify the configuration file, create a new configuration file, or any other corrective action. A determination is made whether corrective action in the form of additional data is received at 304. A new or updated configuration file is generated at 306. A determination is made whether the new or updated configuration file is validated at 308. The process iteratively performs operations 304 through 314 until the configuration file is validated. When validated, the landing zone code is generated at 310 and the landing zone code is deployed at 312. The process terminates thereafter.

In the example of FIG. 3, the configuration file is validated prior to landing zone code generation. However, in other embodiments, the landing zone code is also reviewed, tested, or otherwise validated prior to deployment as well. If the landing zone code fails to be validated, the landing zone manager optionally outputs the feedback to the user identifying a reason the landing zone code failed to be validated and/or recommending a corrective action to address the problem with the configuration file and/or the landing zone code that is intended to render the landing zone code ready for deployment with minimal user intervention.

While the operations illustrated in FIG. 3 are performed by a computing device, aspects of the disclosure contemplate performance of the operations by other entities. In a non-limiting example, a cloud service performs one or more of the operations. In another example, one or more computer-readable storage media storing computer-readable instructions may execute to cause at least one processor to implement the operations illustrated in FIG. 3.

FIG. 4 is an exemplary flow chart illustrating operation of the computing device to validate landing zone generation code created using customized landing zone configuration files. The process 400 shown in FIG. 4 is performed by a landing zone manager component, executing on a computing device, such as the computing device 102 or the user device 116 in FIG. 1.

The process begins by obtaining customized configuration data at operation 402. In this example, the customized configuration data is obtained from a user in response to one or more prompts via a user interface device. In other examples, the customized configuration data is provided by uploading customized policy data via a network, such as, but not limited to, the network 112 in FIG. 1. A configuration file is generated at operation 404. The landing zone manager generates landing zone code using the configuration file at operation 406. The landing zone manager validates the landing zone code using a set of validation rules at operation 408. The validation rules include one or more rules, such as the rule(s) 230 in FIG. 2. The landing zone manager determines whether the landing zone code is validated at operation 410. If yes, the process terminates thereafter. The validated landing zone code is validated for use in deploying workloads for execution in the customized landing zone architecture. If the landing zone code is validated at operation 410, the process terminates thereafter. In this example, the validated landing zone code can be deployed or saved for future deployments.

If the landing zone code is not validated at operation 410, the landing zone manager requests additional configuration data from the user at operation 412. The configuration file is updated with the additional configuration data at operation 414. The landing zone code is generated using the updated configuration file at operation 406. The landing zone code is validated at operation 410. If the landing zone code is valid at operation 410, the process terminates thereafter. If the landing zone code is not validated, the process iteratively executes operations 406 through 414 until the landing zone code is validated. The process terminates thereafter.

While the operations illustrated in FIG. 4 are performed by a computing device, aspects of the disclosure contemplate performance of the operations by other entities. In a non-limiting example, a cloud service performs one or more of the operations. In another example, one or more computer-readable storage media storing computer-readable instructions may execute to cause at least one processor to implement the operations illustrated in FIG. 4.

FIG. 5 is an exemplary flow chart illustrating operation of the computing device to provide customized sovereign landing zone generation code based on user-provided configuration data. The process 500 shown in FIG. 5 is performed by a landing zone manager component, executing on a computing device, such as the computing device 102 or the user device 116 in FIG. 1.

The process begins by receiving one or more policy set(s) at operation 502. A policy set is a set of one or more customized policies provided by the user, such as, but not limited to, the policy set 122 in FIG. 1. The landing zone manager receives a candidate workload selection at operation 504. The landing zone manager creates a customized SLZ configuration at operation 506. The landing zone manager generates the landing zone code at operation 508. The code is generated based on the customized SLZ configuration file. The code is IaC code for deploying a cloud architecture, such as, but not limited to, the landing zone code 134 in FIG. 1 and/or the landing zone code 224 in FIG. 2. The landing zone manager deploys the IaC infrastructure at operation 510. In this example, the infrastructure is deployed in a cloud environment, such as, but not limited to, the cloud server 118 in FIG. 1. The landing zone manager deploys the selected workload in the deployed SLZ at operation 512. A determination is made whether feedback is received from the user at operation 514. The feedback is user input modifying or changing the configuration data or other parameters associated with creating the landing zone architecture. The feedback can include modifications to the configuration data and/or the customized policies provided by the user. If feedback is received at 514, the landing zone manager modifies (updates) the SLZ configuration file in accordance with the feedback provided at operation 516. The system iteratively executes operations 506 through 516 to create a new or updated landing zone code which is used to deploy IaC infrastructure. If feedback is not received at 514 then no additional changes are required following deployment of the IaC infrastructure. The process terminates thereafter.

In some examples, the configuration file and/or the candidate workloads are saved to a data storage, such as, but not limited to, the data storage device 120 in FIG. 1, a cloud storage, or any other type of data storage.

While the operations illustrated in FIG. 5 are performed by a computing device, aspects of the disclosure contemplate performance of the operations by other entities. In a non-limiting example, a cloud service performs one or more of the operations. In another example, one or more computer-readable storage media storing computer-readable instructions may execute to cause at least one processor to implement the operations illustrated in FIG. 5.

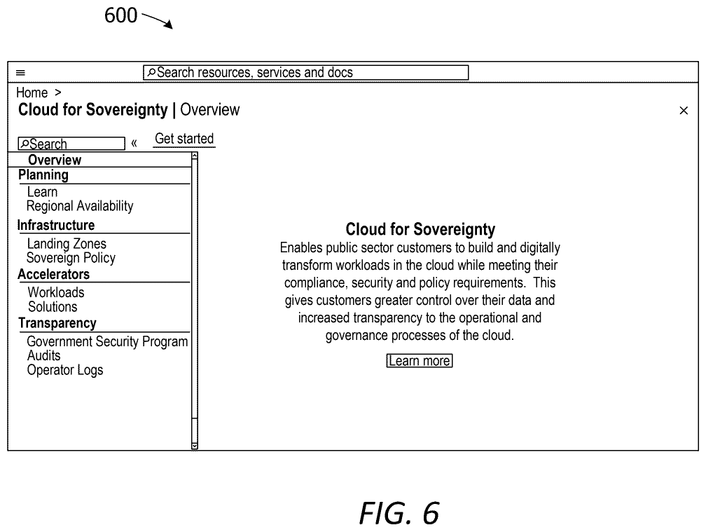

FIG. 6 is an exemplary screenshot 600 illustrating a home page for SLZ architecture configuration and development. The screenshot 600 includes a portal page for accessing the landing zone manager for configuring, validating, and deploying customized cloud architecture.

In some examples, the system includes a sovereign service blade that provides a consolidated view for planning, configuring, deploying, and updating production workloads. It is tailored to meet county and/or agency specific sovereignty requirements. The system provides a platform that allows government agencies and other users to configure and deploy repeatably an approved architecture based on a customized configuration file and/or customized landing zone code that is compliant by design and manage this architecture throughout its lifecycle.

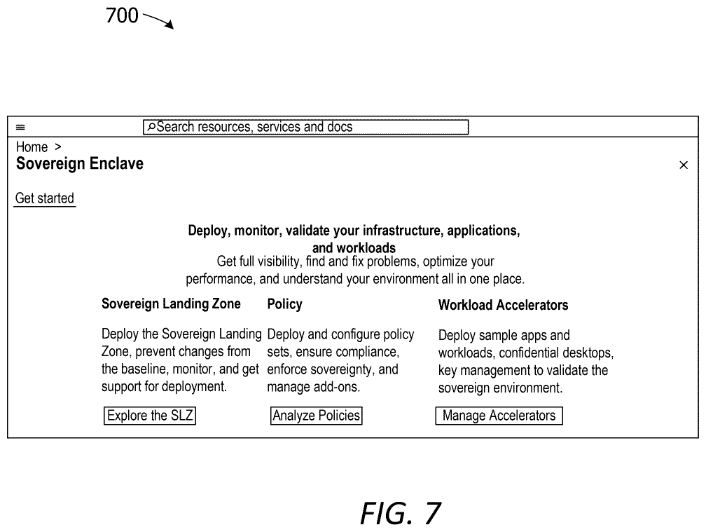

Turning now to FIG. 7, an exemplary screenshot 700 illustrating options for creating a customized sovereign landing zone, customized polices and workloads for execution on a sovereign landing zone architecture is shown. In this example, the screenshot 700 includes options for creating a sovereign landing zone, customized policy, and/or workload accelerator.

In this example scenario, the portal page is accessed by a user or group assessing the feasibility of migrating workloads to one or more commercial clouds, such as, but not limited to, group members with backgrounds in data privacy, cybersecurity, software architecture, legal compliance, and regulatory compliance. The landing zone manager (sovereign service) provides a consolidated view for planning, configuring, deploying, monitoring, and updating production workloads that can be tailored to meet country, and agency, specific sovereignty requirements.

The system allows for comparisons between various available policy frameworks. This feature provides gap analysis between various cloud platform policy initiatives and shows how they compare to the sovereign landing zone policy initiatives, which can be deployed via an open-source offering or directly through the landing zone manager (sovereign service blade). If the users cannot find a policy initiative that aligns with their regulatory compliance framework, the system allows users to upload their own policy compliance file and generate a theoretical custom policy set that can be used as a basis for comparison against the sovereign landing zone policies. If the user does not have a policy file available to upload, the user can search for a pre-defined sovereign service policy set that meets their regulatory requirements. The policy set is imported with appropriate mappings to the landing zone manager. Alternatively, if the users had a compatible policy initiative built for use in the cloud platform, they could upload it to the landing zone manager and use that initiative for comparison, analysis, and deployment.

In another example, a user performing a policy initiative comparison can select a pre-existing SLZ policy that includes desired parameters, such as controls for limiting what cloud platform regions can be used to deploy resources, enforcement of customer managed keys, and/or use of confidential computing resources for workloads that require encryption of data in use. The user can identify desirable features, such as SLZ focus on data residency and mitigating access to data via extra-territorial legal process through policy enforcement of customer managed encryption keys and confidential computing resources. Once the initial gap analysis is completed between the SLZ policy sets and the agency specific custom policy set provided by the user, the user can choose to have the landing zone manager generate the additional custom policies including both pre-existing policies as well as the custom (user-specific) policies they require and use those additional policies in future deployments of the SLZ.

With the policies defined, the landing zone manager conducts a test deployment to evaluate the sovereign service. The system configures and deploys a customized SLZ, with their custom policies applied, directly from the landing zone manager (sovereign service blade). As part of the deployment, the management group architecture, policy assignments, and policy initiatives are continuously monitored for changes with alert notifications being sent to user-provided contacts, such as, but not limited to, provided emails, phone numbers, or other issue trackers. Establishing the monitoring and alerting only requires the user to check boxes and provide the contact information.

Once the deployment is complete, the system identifies user-selected, pre-configured production workloads to deploy for testing. These standard workloads include confidential cloud virtual desktop, virtual machine solutions, cloud-scale analytics, and/or sample applications that bring together all current confidential cloud services for review and analysis. In an example, the system deploys a confidential cloud virtual desktop environment and the confidential sample application because they are not yet ready to put any of the user's own real data in a cloud environment.

After deploying the workloads, the system generates a sovereign service report, such as, but not limited to, the report 236 in FIG. 2. In one example, the report includes environment change alerts that were configured during the initial deployment of the SLZ. All reports are aggregated from several cloud services to provide a view of the cloud environment with a specific focus on sovereignty. This enables fast and efficient configuration and deployment of cloud architecture while mitigating risks related to data residency and lawful access requests.

The report enables the user to review the customized SLZ that is configured and deployed by the system. This gives the user visibility into the policy initiatives, alerting practices, and reporting used in making recommendations. The user has options in how they want to deploy the SLZ for migrating production workloads (assume planning, selection, and readiness analysis for the workloads has been completed). The user can use the SLZ as configured and deployed by the working group. If the user determines the SLZ, as configured, can be used without modification then they can choose to export the configuration as a collection of specific files and/or templates, such as, without limitation, ARM templates, Bicep files, or Terraform files, to be integrated into their existing automation deployment pipelines, or they can make an API call against the system (landing zone manager/sovereign service) and provide the necessary configuration data to have the service deploy the environment. Alternatively, if the user wants to make extensive customizations or additional modifications to the SLZ, the system creates a copy of the configuration file. The user makes modifications to the copied configuration file to create a new configuration or an updated configuration file. The new or updated configuration file, including the new configurations, is deployed into the cloud tenant (making API calls to onboard the environment for monitoring, alerting, and reporting by the landing zone manager).

In an example scenario, the user forks the open-source version, modifies it to meet their needs, integrates it into their existing deployment automation pipeline, and onboard the deployed SLZ to the landing zone manager (sovereign service) for monitoring, alerting, and reporting. Although the user can deploy the SLZ without onboarding to the sovereign service, the user can choose to onboard the service because they appreciate the proactive monitoring for policy compliance in the architecture, policy initiatives, policy assignments, and the notifications they receive when new versions of custom policies in use in their architecture are available for review. Onboarding to the sovereign service also provides visibility via notifications when new versions of the SLZ baseline architecture are available so they can review SLZ updates to determine if they want to integrate landing zone changes over time.

When a cloud platform is being consistently deployed in a manner that meets the policy requirements and architectural needs of the user, the user can begin migrating workloads. By responding to a prompt of the landing zone manager (sovereign service) about the type of workload being migrated, the target SLZ environment being deployed to, and whether the workload leverages confidential computing capabilities, the system provides a deployment sample in a code format and programming language of the user's choice that serves as a starting point for migrating the workload to the selected SLZ. The sample requires customization by the user, but accelerates the user's efforts by providing a starting point that aligns with the sovereign service best practices and the cloud platform best practices while being customized for the SLZ the user wants to target for deployment.

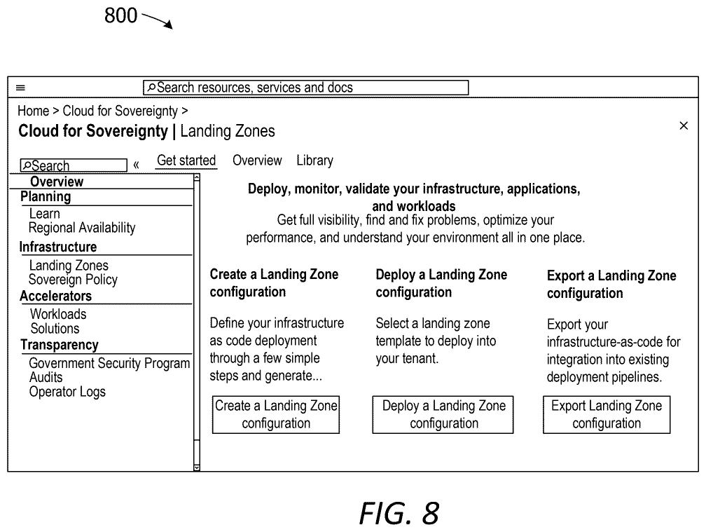

FIG. 8 is an exemplary screenshot 800 illustrating options for creating, deploying, and exporting a customized landing zone configuration. In some examples, the system provides the ability for users to define the desired infrastructure through the cloud portal, including management group structure, cloud policy initiatives assigned at each level of the management group hierarchy, and the connection to the agency's existing virtual network (assuming connectivity to on-premises networks is available for integration). This includes the creation of a new configuration.

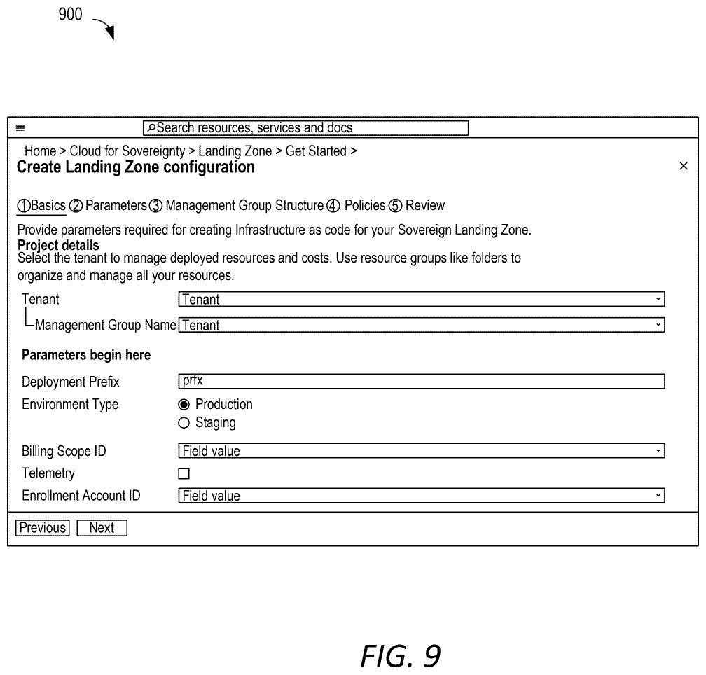

FIG. 9 is an exemplary screenshot 900 illustrating a configuration page for creating infrastructure as code (IaC) for a sovereign landing zone. In some examples, a user can create a landing zone configuration through the portal by selecting a management group to use as the foundation for configuration data. The management group hierarchy, assigned policies, and confidentiality requirements (along with other data as determined) are initially pulled from the running environment and the user is given a chance to edit and update values to create a configuration for comparison. The goal of this feature is to create a configuration from an existing deployed cloud architecture to accelerate adoption by organizations with already deployed infrastructure.

In some examples, the screenshot 900 is a workflow to gather information from the user to create a customized landing zone configuration file. In this example, the workflow includes prompts with data entry fields in which the user can provide input in response to the prompts.

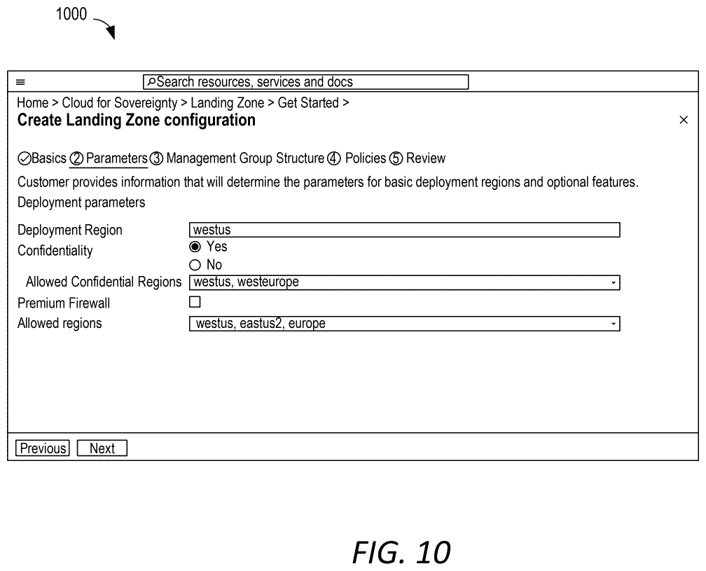

FIG. 10 is an exemplary screenshot 1000 illustrating a configuration page for obtaining customized parameters for creating and deploying a landing zone architecture. The screenshot includes additional prompts for obtaining customized parameters in real-time used to generate the customized configuration file used to generate landing zone code.

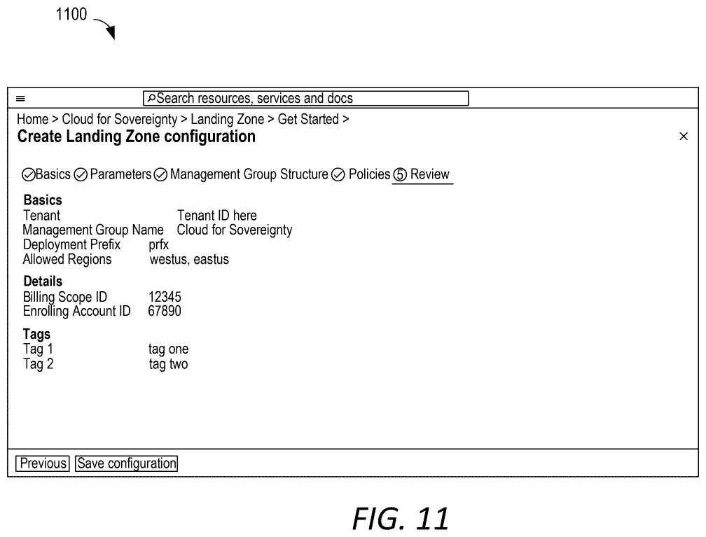

FIG. 11 is an exemplary screenshot 1100 illustrating a review page for a customized landing zone configuration. A user can optionally save a validated configuration. Saved configurations that help users meet their sovereignty and regulatory compliance requirements by storing configurations that can be reused for subsequent deployments.

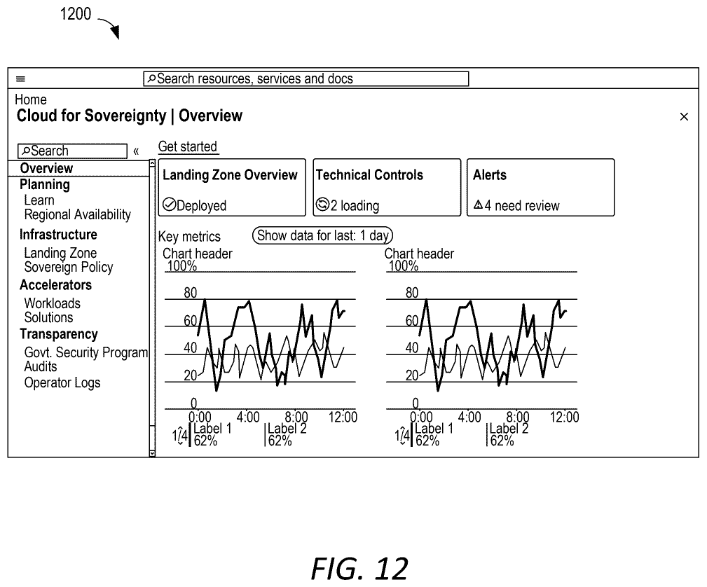

FIG. 12 is an exemplary screenshot 1200 illustrating an overview of deployed landing zones. A user that has already created and/or deployed a landing zone based on an initial configuration can make updates to the configuration based on feedback or other changes before or after the environment is deployed. A landing zone configuration can be updated through API calls until the landing zone configuration is associated with a deployed environment. If a configuration is not yet deployed, the configuration is not yet associated with a deployed environment on the cloud. The user can make changes and save the changes to the configuration file. If the configuration has already been associated with a deployed environment, the configuration file is locked to prevent changes. The user creates a copy of the locked configuration file.

In an example, the landing zone manager creates a copy of the configuration file and add an indicator to the name that it is a copy (could be “copy,” “copy or,” or “v1”, “v2”, etc. depending on experience feedback) and saves as a new configuration in the Landing Zone Library for update/modification. The copied file is not deployed or locked. This permits the user to make edits or other updates/modifications to the landing zone configuration.

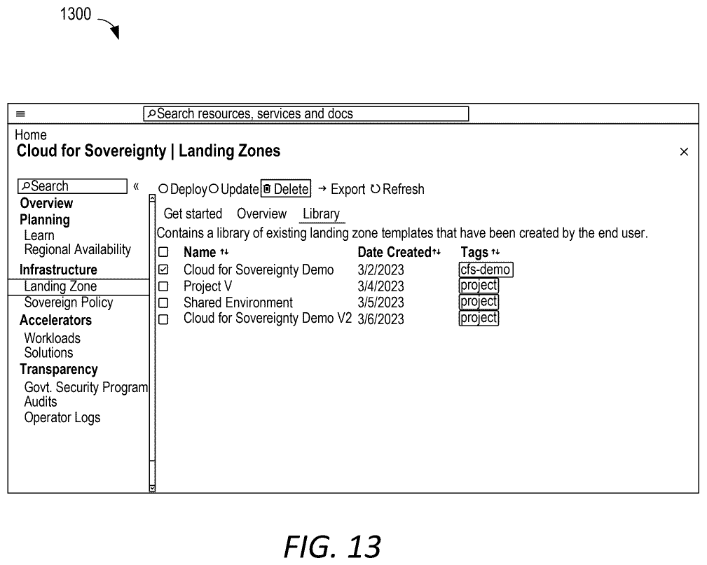

FIG. 13 is an exemplary screenshot 1300 illustrating a library of landing zone configuration templates. The library is a collection of landing zone configurations which are available for deployment or modification by the user. The landing zone configurations are stored in configuration files on a data storage, such as, but not limited to, a data storage device 120 in FIG. 1 and/or a cloud storage. In some examples, the system provides the user the ability to select from a list of pre-defined configurations from the library that meet the user's specific requirements. The user can start from an existing configuration and make updates or modifications without impacting the original configuration. The library optionally provides a default SLZ configuration which can be selected by a user for update/modification as desired.

Thus, in some examples, the landing zone manager enables the user to select a landing zone configuration in the cloud portal and reopen the configuration file details for editing. The user reviews existing parameters and details in the configuration file and makes edits. The system confirms changes have not been made to the landing zone configuration that would prevent the IaC code generation for a landing zone. The system evaluates the configuration to determine if changes were made that would generate valid IaC but where the deployment would still fail due to breaking configuration changes.

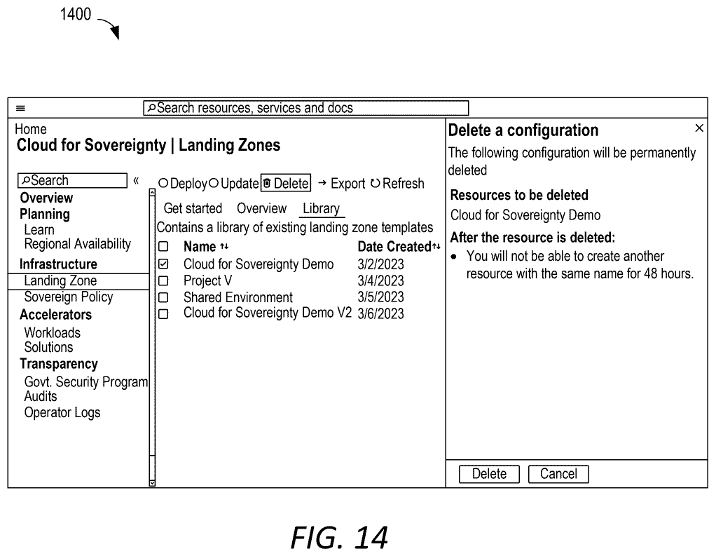

Referring now to FIG. 14, an exemplary screenshot 1400 illustrating a confirmation message for deleting a landing zone configuration template is shown. Landing zone configurations are created, copied and/or deleted via the GUI and/or API. For example, if a user has created multiple versions of a landing zone configuration, the user can delete unwanted versions of the configuration when finalizing the desired version to meet their organization's needs. After deploying and confirming the landing zone configuration, the user deletes old and obsolete configurations remaining in the library. In some examples, this can be completed via the cloud portal.

Thus, in some examples, the system provides the user the ability to select a landing zone configuration for deletion from the library tab and start deletion, as shown in the screenshot 1400. Prior to deletion, the system confirms there are no onboarded landing zones that are using the selected landing zone configuration for calculation of drift or monitoring. If a configuration is being used to compare against one or more running landing zones, the landing zone manager prevents the deletion of the configuration. This relies on on-boarding calls being added to generated code. The generated code includes onboarding functionality to create a mapping when the deployment using the generated code is run. Confirmation of deletion of the selected configuration is presented to the user by the landing zone manager. The deleted landing zone configuration is removed from the library.

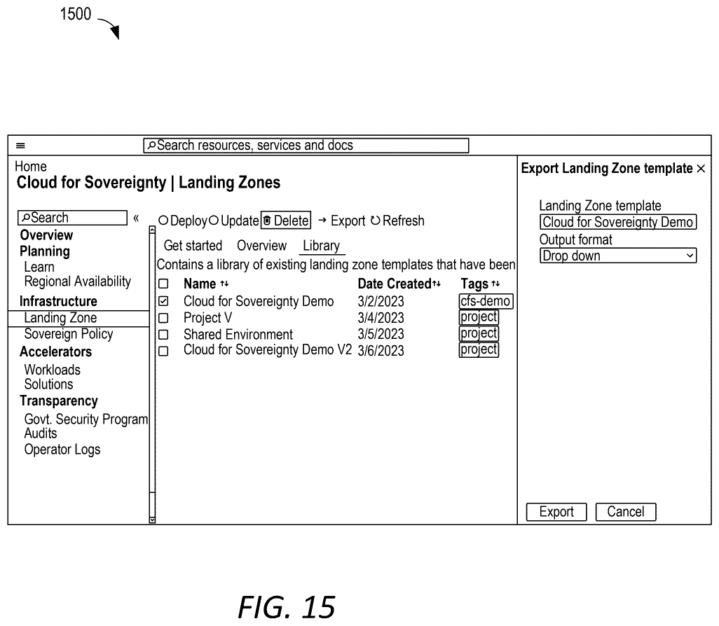

FIG. 15 is an exemplary screenshot 1500 illustrating a page for exporting a landing zone configuration template. In some examples, when a user has finished configuring their landing zone in the portal, from the final configuration page, they can export their landing zone in a variety of available file formats and/or programming languages. Once the user selects the preferred format, the user is prompted to save the file.

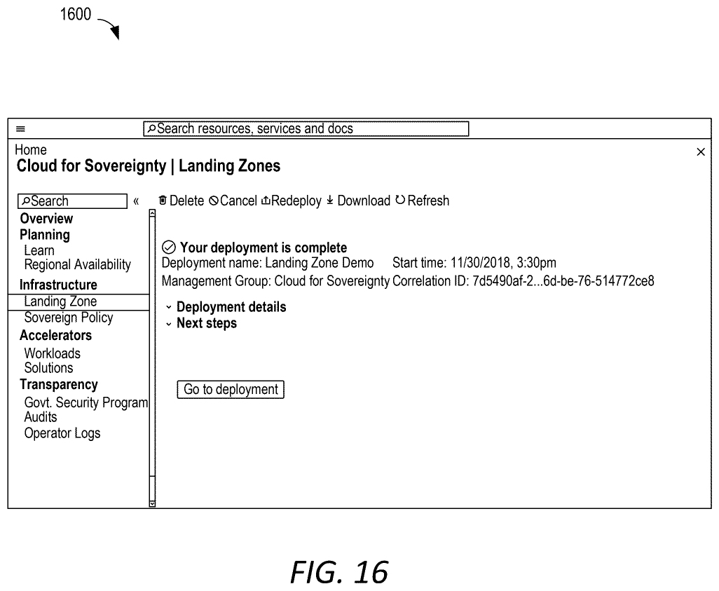

FIG. 16 is an exemplary screenshot 1600 illustrating a landing zone deployment confirmation page. In some examples, an API call is used by a user, such as a cloud administrator, to retrieve a generated landing zone for use in automation pipelines. The user is able to send a landing zone configuration file to the landing zone manager for processing and get back a generated IaC package in the format requested by the user.

Thus, in some examples, the system provides a user with the ability to export landing zone projects via a cloud portal, choose the format that the landing zone configuration is exported in within the cloud portal, download generated landing zone IaC project as a first specified format (e.g., Bicep, or others) via the cloud portal, and/or download generated landing zone IaC project in a second specified format (e.g., ARM, or others) via the cloud portal.

In other examples, the system enables the user to export landing zone configurations via an API, choose the format that the landing zone configuration is exported in when making API calls, download generated landing zone IaC project in the selected format via API calls, and/or download generated landing zone IaC project in a selected file format via API calls. In one example, API registration/onboarding is part of the exported IaC code to automatically onboard during deployment to the cloud. The deployed landing zone is automatically mapped to the configuration that was used to generate it.

A user, such as a cloud administrator, can make edits/updates to an existing landing zone configuration. Examples of edits that could be needed include, but are not limited to, altering custom policies, altering policy sets, changing network configurations, and changing how the workload management group hierarchy is configured. To preserve any existing linking of landing zones in production to landing zone configurations, a copy of the configuration is created when edits have been saved. In some examples, users can customize policy sets and number of management groups. Users can choose to create each of these. However, users cannot customize structure or names associated with the configurations.

During configuration of a landing zone, the system provides an option for a user to add workload accelerators to include as part of their deployment. The workload accelerator tab of the configuration workflow allows a user to add one or multiple workload accelerators as part of their configuration. The overview page also has a section where an administrator can deploy a workload accelerator post landing zone deployment. This allows an administrator to quickly add accelerators of services that can be deployed inside of landing zone and is compliant with the baseline cloud policies.

### Additional Examples

In some examples, the system enables users to create, delete and copy manifest files (landing zone configuration files) via both a GUI in the cloud portal and API calls. In other words, the system optionally enables landing zone deployment via API calls, command line interface (CLI) commands, and/or GUI commands. The system provides policy initiative comparisons and analysis via validation and feedback provided to the user for more accurate landing zone code configuration, generation, and deployment.

In other examples, the system provides custom policy mapping and exclusion definitions, the ability to deploy pre-configured SLZ add-ons from a known location or marketplace, external monitoring to detect landing zone architecture and policy initiative drifts against customer approved baseline, solution workload accelerators pre-configured to work with the customized SLZ, and/or production workload accelerators pre-configured to work with the customized SLZ.

Still other examples provide mechanisms to create, delete, and copy landing zone configurations resources via a cloud portal. The system collects configuration data required to eventually generate landing zone code. The system collects and validates the configuration data that is stored in a landing zone configuration resource and provides version management for configuration files. The system provides mechanisms to create, delete, and copy/clone landing zone configurations.

In an example scenario, a cloud administrator named John works for a government agency and is tasked with creating a secure and compliant infrastructure for their internal use. His agency has strict sovereignty and regulatory compliance requirements. John decides to use the landing zone manager to create and configure the infrastructure. He accesses the cloud portal and selects the landing zone option. The cloud portal guides John through the process of defining the desired infrastructure, management group structure, policy initiatives assigned at each level of the management group hierarchy, and the connection to the agency's existing virtual network. John specifies the necessary configurations for meeting the agency's sovereignty and regulatory compliance requirements, including the location of the virtual machines, the use of encryption for all data in transit and at rest, as well as encryption in use as required, and the use of a could active directory for authentication and authorization. The user does this by selecting from a list of pre-defined templates that meet the agency's specific requirements.

In the above scenario, once John has defined the desired infrastructure, he can save the configuration. The saved configuration can later be used to generate infrastructure-as-code using templates. The generated code can be exported, as a zip archive, for deployment through CLI or CI/CD pipelines, or John can complete the deployment through the cloud portal. John can quickly, easily, and securely create a compliant infrastructure that meets the agency's sovereignty and regulatory compliance requirements, using the landing zone manager, including the cloud portal. The system provides a sovereign and compliant cloud solution specifically designed for government agencies, delivering the security, privacy, and control that these organizations require.

Other examples provide automatic creation of new configuration file version each time a new configuration is created, or an existing configuration is updated. This enables the ability to access different versions of a configuration from within the cloud portal and view the history of changes. The system can compare differences between versions and roll back to a previous version is necessary. This enables a centralized, auditable, and secure way to manage configurations used for no code IaC within the cloud portal. This enables the ability to create configuration snapshots that can aggregate multiple changes into a new saved version, instead of automatically creating a new version with each save. Each configuration is optionally marked as a new version or snapshot after one or more edits have been made and saved to the configuration.

In yet another scenario, a government agency using a no code or low-code IaC approach in the cloud portal for several months created and managed the configurations using a combination of pre-defined templates and the administrator's selections. The agency now wants to version and manage the configurations as part of a service to ensure that changes can be tracked and rolled back if necessary. To accomplish this, the agency uses the built-in versioning capabilities of the landing zone manager for the configurations within the cloud portal. Each time a new configuration is created, or an existing configuration is updated, a new version is automatically created. The administrator can access different versions from within the portal to see the history of changes, compare different versions, and roll back to a previous version if necessary. All previous versions of the configurations are available for audit and rollback purposes. This versioning and management system provides the agency with a centralized, auditable, and secure way to manage the configurations used for no code IaC within the cloud portal. The service provides a streamlined process for creating and managing the IaC while ensuring that all governance and regulatory requirements are met.

Other examples provide the ability to define the desired infrastructure configuration through an API, including management group structure, policy initiatives assigned at each level of the management group hierarchy, and the connection to the agency's existing virtual network. A user can make an API call that creates a configuration and onboard an existing management group hierarchy for comparison. This requires the user to know what data they want to post as part of the configuration creation in the API.

The system, in other examples, provides an intuitive, no-code interface for managing the deployment and automatically monitors the deployed resources in a cloud environment, comparing them to the desired configuration defined in the service's interface. If any differences are detected, the system generates a report that highlights the differences and provides recommendations for resolving the issues, including any differences between the deployed cloud policy initiatives and the intended configuration as well as changes to the configure the management group structure (including assigned policy initiatives at each level of the hierarchy). The user can review the report and act directly from the service's interface, either by applying the recommended changes or by manually making the necessary corrections. This approach eliminates the need for complex custom scripts and manual comparisons and ensures that customer sovereignty is maintained.

In other examples, the system provides point in time assessment of deployed cloud resources (management group structure, policy initiatives assigned and each level of the management group hierarchy, and the version of policy initiatives being used at each level of the architecture), comparing them to desired configuration defined in the service's interface. The system generates reports highlighting any differences that are detected. Monitoring and remediation of cloud policy initiatives is provided with intuitive, no-code interface for managing deployments. The system provides recommendations for resolving issues and applying changes, including differences between the deployed policy initiatives and the intended configuration. Recommended changes can be applied automatically or manually to make necessary corrections. Automatic continuous assessment of deployed resources enables comparison to desired configurations defined in the service's interface.

In still other examples, the system includes a chatbot for providing text or verbal prompts to user to obtain information from the user. In an example, the chatbot asks the user questions and provides recommendations based on the user's answers. The chatbot also performs real-time validation and makes suggestions for alternative configurations if there are compliance issues. In the end, the chatbot creates the infrastructure-as-code configuration without the user having to manually enter any code. This no code approach allows the user to focus on the agency's business requirements, while the chatbot manages the technical details of the infrastructure-as-code configuration. So, the large language model with a chatbot provides an efficient and user-friendly way to create and configure the infrastructure-as-code while meeting all governance and regulatory requirements.

Alternatively, or in addition to the other examples described herein, examples include any combination of the following:
validate the customized configuration file for compliance with a set of network configurations;
provide a second set of prompts requesting additional configuration data from the user in response to failure to validate the customized configuration file;
modify the customized configuration file using the additional configuration data;
provide feedback to the user via the user interface device in response to failure to validate the customized configuration file;
map each token in the set of dynamic code segments in the landing zone configuration template to configuration data provided by the user in response to a prompt in the set of prompts;
obtain the customized configuration data using a series of natural language questions provided via the set of prompts;
deploy workloads via the customized landing zone infrastructure compliant with the set of user-specific policies;
presenting a set of prompts requesting customized configuration data corresponding to a set of dynamic code segments of a landing zone configuration template via a user interface device, the landing zone configuration template comprising a set of static code segments and the set of dynamic code segments;
creating a customized configuration file using the customized configuration data obtained from a user in response to the set of prompts and the set of static code segments;
generating customized landing zone code using the customized configuration file, the customized configuration file comprising a set of user-specific policies;
validating the customized landing zone code for compliance with the set of user-specific policies;
deploying a customized landing zone infrastructure defined by the customized configuration file using the customized landing zone code to perform workloads via a cloud server;
validating the customized configuration file for compliance with a set of network configurations;
providing a second set of prompts requesting additional configuration data from the user in response to failure to validate the customized configuration file;
modifying the customized configuration file using the additional configuration data;
providing feedback to the user via the user interface device in response to failure to validate the customized configuration file;
mapping each token in the set of dynamic code segments in the landing zone configuration template to configuration data provided by the user in response to a prompt in the set of prompts;
obtaining the customized configuration data using a series of natural language questions provided via the set of prompts;
deploying workloads via the customized landing zone infrastructure compliant with the set of user-specific policies;
map a set of tokens in the set of dynamic code segments in the landing zone configuration template to configuration data provided by the user in response to a prompt in the set of prompts; and
obtain the customized configuration data using a series of natural language questions provided by a chatbot.

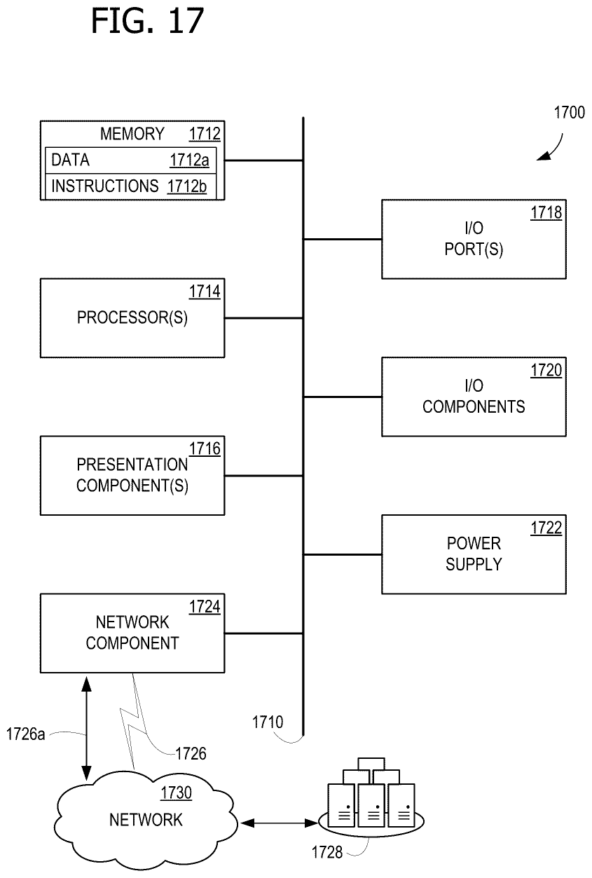

At least a portion of the functionality of the various elements in FIG. 1, FIG. 2, and FIG. 17 can be performed by other elements in FIG. 1, FIG. 2, and FIG. 17, or an entity (e.g., processor 106, web service, server, application program, computing device, etc.) not shown in FIG. 1, FIG. 2, and FIG. 17.

In some examples, the operations illustrated in FIG. 3, FIG. 4, and/or FIG. 5 can be implemented as software instructions encoded on a computer-readable medium, in hardware programmed or designed to perform the operations, or both. For example, aspects of the disclosure can be implemented as a system on a chip or other circuitry including a plurality of interconnected, electrically conductive elements.

In other examples, a computer readable medium having instructions recorded thereon which when executed by a computer device cause the computer device to cooperate in performing a method of configuring, generating, validating and/or deploying customized cloud infrastructure, the method comprising presenting a set of prompts requesting customized configuration data corresponding to a set of dynamic code segments of a landing zone configuration template via a user interface device, the landing zone configuration template comprising a set of static code segments and the set of dynamic code segments; creating a customized configuration file using the customized configuration data obtained from a user in response to the set of prompts and the set of static code segments; generating customized landing zone code using the customized configuration file, the customized configuration file comprising a set of user-specific policies; validating the customized landing zone code for compliance with the set of user-specific policies; and deploying a customized landing zone infrastructure defined by the customized configuration file using the customized landing zone code to perform workloads via a cloud server.

While the aspects of the disclosure have been described in terms of various examples with their associated operations, a person skilled in the art would appreciate that a combination of operations from any number of different examples is also within scope of the aspects of the disclosure.

The term “Wi-Fi” as used herein refers, in some examples, to a wireless local area network using high frequency radio signals for the transmission of data. The term “BLUETOOTH®” as used herein refers, in some examples, to a wireless technology standard for exchanging data over short distances using short wavelength radio transmission. The term “NFC” as used herein refers, in some examples, to a short-range high frequency wireless communication technology for the exchange of data over short distances.

While no personally identifiable information is tracked by aspects of the disclosure, examples have been described with reference to data monitored and/or collected from the users. In some examples, notice is provided to the users of the collection of the data (e.g., via a dialog box or preference setting) and users are given the opportunity to give or deny consent for the monitoring and/or collection. The consent can take the form of opt-in consent or opt-out consent.

### Exemplary Operating Environment

FIG. 17 is a block diagram of an example computing device 1700 for implementing aspects disclosed herein and is designated as computing device 1700. The computing device 1700 is a computing device, such as the computing device 102 in FIG. 1. The computing device 1700 is an example of a suitable computing environment and is not intended to suggest any limitation as to the scope of use or functionality of the examples disclosed herein. Neither should the computing device 1700 be interpreted as having any dependency or requirement relating to any one or combination of components/modules illustrated. The examples disclosed herein may be described in the general context of computer code or machine-useable instructions, including computer-executable instructions such as program components, being executed by a computer or other machine, such as a personal data assistant or other handheld device.

Program components including routines, programs, objects, components, data structures, and the like, refer to code that performs particular tasks, or implement particular abstract data types. The disclosed examples may be practiced in a variety of system configurations, including personal computers, laptops, smart phones, mobile tablets, hand-held devices, consumer electronics, specialty computing devices, etc. The disclosed examples may also be practiced in distributed computing environments when tasks are performed by remote-processing devices that are linked through a communications network.

Computing device 1700 includes a bus 1710 that directly or indirectly couples the following devices: computer-storage memory 1712, one or more processors 1714, one or more presentation components 1716, I/O ports 1718, I/O components 1720, a power supply 1722, and a network component 1724. While computing device 1700 is depicted as a single device, multiple computing devices 1700 may work together and share the depicted device resources. For example, memory 1712 may be distributed across multiple devices, and processor(s) 1714 may be housed with different devices.

Bus 1710 represents what may be one or more buses (such as an address bus, data bus, or a combination thereof). Although the various blocks of FIG. 17 are shown with lines for the sake of clarity, delineating various components may be accomplished with alternative representations. For example, a presentation component such as a display device is an I/O component in some examples, and some examples of processors have their own memory. Distinction is not made between such categories as “workstation,” “server,” “laptop,” “hand-held device,” etc., as all are contemplated within the scope of FIG. 17 and the references herein to a “computing device.”

Memory 1712 may take the form of the computer-storage media references below and operatively provide storage of computer-readable instructions, data structures, program modules and other data for computing device 1700. In some examples, memory 1712 stores one or more of an operating system, a universal application platform, or other program modules and program data. Memory 1712 is thus able to store and access data 1712a and instructions 1712b that are executable by processor 1714 and configured to carry out the various operations disclosed herein.

In some examples, memory 1712 includes computer-storage media in the form of volatile and/or nonvolatile memory, removable or non-removable memory, data disks in virtual environments, or a combination thereof. Memory 1712 may include any quantity of memory associated with or accessible by computing device 1700. Memory 1712 may be internal to computing device 1700 (as shown in FIG. 17), external to computing device 1700 (not shown), or both (not shown).

Examples of memory 1712 in include, without limitation, RAM; read only memory (ROM); electronically erasable programmable read only memory (EEPROM); flash memory or other memory technologies; CD-ROM, digital versatile disks (DVDs) or other optical or holographic media; magnetic cassettes, magnetic tape, magnetic disk storage or other magnetic storage devices; memory wired into an analog computing device; or any other medium for encoding desired information and for access by computing device 1700. Additionally, or alternatively, memory 1712 may be distributed across multiple computing devices 1700, for example, in a virtualized environment in which instruction processing is carried out on multiple computing devices 1700. For the purposes of this disclosure, “computer storage media,” “computer storage device,” “computer-storage memory,” “memory,” and “memory devices” are synonymous terms for computer-storage memory 1712, and none of these terms include carrier waves or propagating signaling. In some examples, the memory 1712 is a memory such as, but not limited to, the memory 108 in FIG. 1.

Processor(s) 1714 may include any quantity of processing units that read data from various entities, such as memory 1712 or I/O components 1720 and may include CPUs and/or GPUs. Specifically, processor(s) 1714 are programmed to execute computer-executable instructions for implementing aspects of the disclosure. The instructions may be performed by the processor, by multiple processors within computing device 1700, or by a processor external to client computing device 1700. In some examples, processor(s) 1714 are programmed to execute instructions such as those illustrated in the in the accompanying drawings.

Moreover, in some examples, processor(s) 1714 represent an implementation of analog techniques to perform the operations described herein. For example, the operations may be performed by an analog client computing device 1700 and/or a digital client computing device 1700. In some examples, the processor(s) 1714 include one or more processors, such as but not limited to, the processor 106 in FIG. 1.

Presentation component(s) 1716 presents data indications to a user or other device. Exemplary presentation components include a display device, speaker, printing component, vibrating component, etc. One skilled in the art will understand and appreciate that computer data may be presented in a number of ways, such as visually in a GUI, audibly through speakers, wirelessly between computing devices 1700, across a wired connection, or in other ways. I/O ports 1718 allow computing device 1700 to be logically coupled to other devices including I/O components 1720, some of which may be built in. Example I/O components 1720 include, for example but without limitation, a microphone, joystick, game pad, satellite dish, scanner, printer, wireless device, etc.

Computing device 1700 may operate in a networked environment via network component 1724 using logical connections to one or more remote computers. In some examples, network component 1724 includes a network interface card and/or computer-executable instructions (e.g., a driver) for operating the network interface card. Communication between computing device 1700 and other devices may occur using any protocol or mechanism over any wired or wireless connection.

In some examples, network component 1724 is operable to communicate data over public, private, or hybrid (public and private) using a transfer protocol, between devices wirelessly using short range communication technologies (e.g., near-field communication (NFC), Bluetooth™M branded communications, or the like), or a combination thereof. Network component 1724 communicates over wireless communication link 1726 and/or a wired communication link 1726a to a cloud resource 1728 across network 1730. Various different examples of communication links 1726 and 1726a include a wireless connection, a wired connection, and/or a dedicated link, and in some examples, at least a portion is routed through the internet.

Exemplary computer-readable media include flash memory drives, digital versatile discs (DVDs), compact discs (CDs), floppy disks, and tape cassettes. By way of example and not limitation, computer-readable media comprise computer storage media and communication media. Computer storage media include volatile and nonvolatile, removable, and non-removable media implemented in any method or technology for storage of information such as computer-readable instructions, data structures, program modules and the like. Computer storage media are tangible and mutually exclusive to communication media. Computer storage media are implemented in hardware and exclude carrier waves and propagated signals. Computer storage media for purposes of this disclosure are not signals per se. Exemplary computer storage media include hard disks, flash drives, and other solid-state memory. In contrast, communication media typically embody computer-readable instructions, data structures, program modules, or the like, in a modulated data signal such as a carrier wave or other transport mechanism and include any information delivery media.

Although described in connection with an exemplary computing system environment, examples of the disclosure are capable of implementation with numerous other special purpose computing system environments, configurations, or devices.

Examples of well-known computing systems, environments, and/or configurations that can be suitable for use with aspects of the disclosure include, but are not limited to, mobile computing devices, personal computers, server computers, hand-held or laptop devices, multiprocessor systems, gaming consoles, microprocessor-based systems, set top boxes, programmable consumer electronics, mobile telephones, mobile computing and/or communication devices in wearable or accessory form factors (e.g., watches, glasses, headsets, or earphones), network PCs, minicomputers, mainframe computers, distributed computing environments that include any of the above systems or devices, and the like. Such systems or devices can accept input from the user in any way, including from input devices such as a keyboard or pointing device, via gesture input, proximity input (such as by hovering), and/or via voice input.

Examples of the disclosure can be described in the general context of computer-executable instructions, such as program modules, executed by one or more computers or other devices in software, firmware, hardware, or a combination thereof. The computer-executable instructions can be organized into one or more computer-executable components or modules. Generally, program modules include, but are not limited to, routines, programs, objects, components, and data structures that perform tasks or implement abstract data types. Aspects of the disclosure can be implemented with any number and organization of such components or modules. For example, aspects of the disclosure are not limited to the specific computer-executable instructions, or the specific components or modules illustrated in the figures and described herein. Other examples of the disclosure can include different computer-executable instructions or components having more functionality or less functionality than illustrated and described herein.

In examples involving a general-purpose computer, aspects of the disclosure transform the general-purpose computer into a special-purpose computing device when configured to execute the instructions described herein.

The examples illustrated and described herein as well as examples not specifically described herein but within the scope of aspects of the disclosure constitute exemplary means for customized landing zone code generation and deployment. For example, the elements illustrated in FIG. 1, FIG. 2, and FIG. 17, such as when encoded to perform the operations illustrated in FIG. 3, FIG. 4, and FIG. 5, constitute exemplary means for presenting a set of prompts requesting customized configuration data corresponding to a set of dynamic code segments of a landing zone configuration template via a user interface device, the landing zone configuration template comprising a set of static code segments and the set of dynamic code segments; exemplary means for creating a customized configuration file using the customized configuration data obtained from a user in response to the set of prompts and the set of static code segments; exemplary means for generating customized landing zone code using the customized configuration file, the customized configuration file comprising a set of user-specific policies; exemplary means for validating the customized landing zone code for compliance with the set of user-specific policies; and exemplary means for deploying a customized landing zone infrastructure defined by the customized configuration file using the customized landing zone code to perform workloads via a cloud server.

Other non-limiting examples provide one or more computer storage devices having a first computer-executable instructions stored thereon for providing customized landing zone code generation and deployment. When executed by a computer, the computer performs operations including presenting a set of prompts requesting customized configuration data corresponding to a set of dynamic code segments of a landing zone configuration template via a user interface device, the landing zone configuration template comprising a set of static code segments and the set of dynamic code segments; creating a customized configuration file using the customized configuration data obtained from a user in response to the set of prompts and the set of static code segments; generating customized landing zone code using the customized configuration file, the customized configuration file comprising a set of user-specific policies; validating the customized landing zone code for compliance with the set of user-specific policies; and deploying a customized landing zone infrastructure defined by the customized configuration file using the customized landing zone code to perform workloads via a cloud server.

The order of execution or performance of the operations in examples of the disclosure illustrated and described herein is not essential, unless otherwise specified. That is, the operations can be performed in any order, unless otherwise specified, and examples of the disclosure can include additional or fewer operations than those disclosed herein. For example, it is contemplated that executing or performing an operation before, contemporaneously with, or after another operation is within the scope of aspects of the disclosure.

The indefinite articles “a” and “an,” as used in the specification and in the claims, unless clearly indicated to the contrary, should be understood to mean “at least one.” The phrase “and/or” as used in the specification and in the claims, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to “A” only (optionally including elements other than “B”); in another embodiment, to B only (optionally including elements other than “A”); in yet another embodiment, to both “A” and “B” (optionally including other elements); etc.

As used in the specification and in the claims, “or” should be understood to have the same meaning as “and/or” as defined above. For example, when separating items in a list, “or” or “and/or” shall be interpreted as being inclusive, i.e., the inclusion of at least one, but also including more than one of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used shall only be interpreted as indicating exclusive alternatives (i.e., “one or the other but not both”) when preceded by terms of exclusivity, such as “either” “one of” “only one of” or “exactly one of.” “Consisting essentially of,” when used in the claims, shall have its ordinary meaning as used in the field of patent law.

As used in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of ‘A’ and ‘B’” (or, equivalently, “at least one of ‘A’ or ‘B’,” or, equivalently “at least one of ‘A’ and/or ‘B’”) can refer, in one embodiment, to at least one, optionally including more than one, “A”, with no “B” present (and optionally including elements other than “B”); in another embodiment, to at least one, optionally including more than one, “B”, with no “A” present (and optionally including elements other than “A”); in yet another embodiment, to at least one, optionally including more than one, “A”, and at least one, optionally including more than one, “B” (and optionally including other elements); etc.

The use of “including,” “comprising,” “having,” “containing,” “involving,” and variations thereof, is meant to encompass the items listed thereafter and additional items.

Use of ordinal terms such as “first,” “second,” “third,” etc., in the claims to modify a claim element does not by itself connote any priority, precedence, or order of one claim element over another or the temporal order in which acts of a method are performed. Ordinal terms are used merely as labels to distinguish one claim element having a certain name from another element having a same name (but for use of the ordinal term), to distinguish the claim elements.

Having described aspects of the disclosure in detail, it will be apparent that modifications and variations are possible without departing from the scope of aspects of the disclosure as defined in the appended claims. As various changes could be made in the above constructions, products, and methods without departing from the scope of aspects of the disclosure, it is intended that all matter contained in the above description and shown in the accompanying drawings shall be interpreted as illustrative and not in a limiting sense.

What is claimed is:

1. A system for customized landing zone code generation and deployment, the system comprising:
a processor; and
a computer-readable medium storing instructions that are operative upon execution by the processor to:
present a set of prompts requesting customized configuration data associated with a landing zone configuration template via a user interface device;
create a customized configuration file using the customized configuration data, the customized configuration data received in response to the set of prompts;
generate customized landing zone code using the customized configuration file, the customized configuration file comprising a set of user-specific policies; and
deploy a customized landing zone infrastructure with reduced network bandwidth usage, the customized landing zone infrastructure is defined by the customized configuration file using the customized landing zone code to perform workloads via a cloud server.

2. The system of claim 1, wherein the instructions are further operative to:
validate the customized configuration file for compliance with the set of user-specific policies and a set of network configurations.

3. The system of claim 1, wherein the instructions are further operative to:
validate the customized landing zone code for compliance with the set of user-specific policies.

4. The system of claim 1, wherein the instructions are further operative to:
provide feedback via the user interface device in response to failure to validate the customized configuration file or the customized landing zone code.

5. The system of claim 1, wherein the landing zone configuration template comprising a set of static code segments and a set of dynamic code segments, and wherein the instructions are further operative to:
map each token in the set of dynamic code segments in the landing zone configuration template to configuration data received in response to a prompt in the set of prompts.

6. The system of claim 1, wherein the instructions are further operative to:
obtain the customized configuration data using a series of natural language questions provided via the set of prompts.

7. The system of claim 1, wherein the instructions are further operative to:
deploy workloads via the customized landing zone infrastructure that is compliant with the set of user-specific policies.

8. A method for customized landing zone code generation and deployment, the method comprising:
presenting a set of prompts requesting customized configuration data corresponding to a set of dynamic code segments of a landing zone configuration template via a user interface device, the landing zone configuration template comprising a set of static code segments and the set of dynamic code segments;
creating a customized configuration file using the customized configuration data obtained from a user in response to the set of prompts and the set of static code segments;
generating customized landing zone code using the customized configuration file, the customized configuration file comprising a set of user-specific policies;
validating the customized landing zone code for compliance with the set of user-specific policies; and
deploying a customized landing zone infrastructure defined by the customized configuration file using the customized landing zone code to perform workloads via a cloud server.

9. The method of claim 8, further comprising:
validating the customized configuration file for compliance with a set of network configurations.

10. The method of claim 8, further comprising:
providing a second set of prompts requesting additional configuration data from the user in response to failure to validate the customized configuration file; and
modifying the customized configuration file using the additional configuration data.

11. The method of claim 8, further comprising:
providing feedback to the user via the user interface device in response to failure to validate the customized configuration file.

12. The method of claim 8, further comprising:
mapping each token in the set of dynamic code segments in the landing zone configuration template to configuration data provided by the user in response to a prompt in the set of prompts.

13. The method of claim 8, further comprising:
obtaining the customized configuration data using a series of natural language questions provided via the set of prompts.

14. The method of claim 8, further comprising:
deploying workloads via the customized landing zone infrastructure that is compliant with the set of user-specific policies.

15. One or more computer storage devices having computer-executable instructions stored thereon, which, upon execution by a computer, cause the computer to perform operations comprising:
present a set of prompts requesting customized configuration data corresponding to a set of dynamic code segments of a landing zone configuration template via a user interface device, the landing zone configuration template comprising a set of static code segments and the set of dynamic code segments;
create a customized configuration file using the customized configuration data obtained from a user in response to the set of prompts and the set of static code segments;
generate customized landing zone code using the customized configuration file, the customized configuration file comprising a set of user-specific policies;
validate the customized landing zone code for compliance with the set of user-specific policies; and
deploy a customized landing zone infrastructure defined by the customized configuration file using the customized landing zone code to perform workloads via a cloud server.

16. The one or more computer storage devices of claim 15, wherein the operations further comprise:
validate the customized configuration file for compliance with a set of network configurations.

17. The one or more computer storage devices of claim 15, wherein the operations further comprise:
provide a second set of prompts requesting additional configuration data from the user in response to failure to validate the customized configuration file; and
modify the customized configuration file using the additional configuration data.

18. The one or more computer storage devices of claim 15, wherein the operations further comprise:
generate feedback to the user via the user interface device in response to failure to validate the customized configuration file.

19. The one or more computer storage devices of claim 15, wherein the operations further comprise:
map a set of tokens in the set of dynamic code segments in the landing zone configuration template to configuration data provided by the user in response to a prompt in the set of prompts.

20. The one or more computer storage devices of claim 15, wherein the operations further comprise:
obtain the customized configuration data using a series of natural language questions provided by a chatbot.
